(19) United States
(12) Patent Application Publication
(10) Pub. No.: US 2024/0142660 A1
(43) Pub. Date: May 2, 2024

(54) METHOD AND SYSTEM FOR INDIRECT MEASUREMENT OF GRAVITY

(71) Applicant: Wuhan University, Wuhan (CN)

(72) Inventor: Tao ZHANG, Wuhan (CN)

(21) Appl. No.: 18/523,846

(22) Filed: Nov. 29, 2023

Related U.S. Application Data
(63) Continuation-in-part of application No. PCT/CN2022/096070, filed on May 30, 2022.

(30) Foreign Application Priority Data
May 31, 2021 (CN) 202110599628.8

(51) Int. Cl. G01V 7/06; G06F 17/16

(52) U.S. Cl. CPC G01V 7/06; G06F 17/16

(57) ABSTRACT

The disclosure provides an indirect method for measuring gravity based on the synthesis of gravitational forces generated by celestial bodies, gravitational forces generated by the Earth and other inertial forces, resulting in changes in the gravitational acceleration of the position to be measured. By regularly monitoring the direction change of gravitational acceleration of the position, the gravity measurement result of such position is deduced. When monitoring the direction change of gravitational acceleration, measure the direction of gravity at each moment, and obtain observation data on the direction change of gravitational acceleration. According to its own coordinates, the approximate value of the acceleration vector caused by the current position of the Earth is obtained as the initial solution, and the estimation data of gravity acceleration direction change is calculated, combined with the observation data of gravity acceleration direction change, and the gravity measurement result is obtained by iterative linearization.

### CROSS-REFERENCE TO RELATED APPLICATIONS

This application is a continuation-in-part of International Patent Application No. PCT/CN2022/096070 with an international filing date of May 30, 2022, designating the United States, now pending, and further claims foreign priority benefits to Chinese Patent Application No. 202110599628.8 filed May 31, 2021. The contents of all of the aforementioned applications, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, Cambridge, MA 02142.

### BACKGROUND

The disclosure relates to the field of measurement technology, and more particularly to a method for indirect measurement of gravity.

Gravity measurement plays an important role in geodesy, geophysics, resource exploration, ocean research, and military affairs. At present, the methods for gravity measurement mainly include laser interference, atomic interference, spring-based, superconductivity-based, and other related technologies. The measurement precision is constantly improving, with the scope of application expanding from the initial free fall method to quantum and superconductivity. Despite these upgrades, the overall structure remains complex and the requirements for use remain stringent.

At present, the gravimeter is a high-end instrument with a price tag of roughly several hundred thousand to one million dollars.

In the United States, there are many famous manufacturers of gravimeters, including Lacoste & Romberg gravity meters Inc., Laurel, GWR, etc.

### SUMMARY

To solve the above shortcomings in the prior art, the disclosure provides a method for indirectly measuring gravity.

To obtain the above objectives, the disclosure provides a method for indirect measurement of gravity, which is based on resultant gravitational force generated by celestial bodies, gravitational force generated by the Earth, and other inertial forces, resulting in the change of gravitational acceleration of the position to be measured. By regularly monitoring the direction change of gravitational acceleration of the position to be measured, the gravity measurement result of such position can be deduced.

By measuring the direction of gravity θ₁, θ₂, . . . , θₖ₊₁ at time t₁, t₂, . . . , tₖ₊₁, the observed direction change of gravitational acceleration can be obtained: Δθᵢ=θᵢ₊₁−θᵢ (i =1 . . . k). Supposing that the acceleration vectors V₁, V₂, . . . , Vₖ₊₁ generated by resultant gravitational forces of related celestial bodies at time t₁, t₂, . . . , tₖ₊₁ can be calculated according to their coordinates

$$[ \begin{matrix}x \\ y \\ z\end{matrix} ]$$

and positions, the direction change of gravitational acceleration can be estimated: ΔVᵢ=Vᵢ₊₁−Vᵢ(i=1 . . . k, where, k is an integer not less than 3). Supposing that the acceleration caused by the Earth's gravitational force is a three-dimensional vector

$$[ \begin{matrix}x \\ g y \\ g z\end{matrix} ] ,$$

the equation system for calculating the direction change of gravitational acceleration is established as follows:

$$\{ \begin{matrix}Δ {V}_{1} = f ( gx , gy , gz , {t}_{1} , {t}_{2} ) \\ Δ {V}_{2} = f ( gx , gy , gz , {t}_{2} , {t}_{3} ) \\ Δ {V}_{3} = f ( gx , gy , gz , {t}_{3} , {t}_{4} ) \\ … …\end{matrix}$$

Where f() is a function of direction change with respect to

$$[ \begin{matrix}g x \\ g y \\ g z\end{matrix} ] ;$$

The gravity measurement results at the position to be measured can be deduced. The method is as follows: self-coordinates

$$[ \begin{matrix}x \\ y \\ z\end{matrix} ]$$

are used to calculate approximate value

$$[ \begin{matrix}g {x}_{0} \\ g {y}_{0} \\ g {z}_{0}\end{matrix} ]$$

of the acceleration vector generated by the Earth at the current position, and the approximate value is used as an initial solution to calculate the estimated direction change of gravitational acceleration. Then observed direction change of gravitational acceleration and relevant equation system are used to iterate until the error converges to be less than the error limit, thereby getting the gravity measurement results.

Moreover, the direction change of gravitational acceleration is monitored by an inclinometer.

To accurately calculate the positions of celestial bodies, it is essential to use a high-precision clock, such as an atomic clock, to determine the current time.

The self-coordinates can be obtained by a GNSS receiver, inertial positioning device or geomagnetic field positioning device.

If a positioning device is not available, there are 6 unknown variables: 3 dimension positions and 3 axis gravity vectors—that can be solved by collecting data from at least seven observations.

The celestial bodies include the Sun, the Moon and other near earth celestial bodies.

The method of calculating the estimated direction change of gravitational acceleration is as follows:

Calculate the acceleration vector

$$[ \begin{matrix}C x \\ C y \\ C z\end{matrix} ]$$

generated by the Earth's rotation according to its position and the Earth's rotation speed.

The acceleration aₑₘ and its direction vₑₘ in the Earth-Moon system are calculated according to the time, lunar mass, lunar coordinates, gravitational constant, geocentric coordinates, and its self-position.

The acceleration aₛₑ and its direction vₛₑ in the Sun-Earth system are calculated according to the time, solar mass, solar coordinates, gravitational constant, geocentric coordinates, and its self-position.

Make a vector synthesis with the acceleration vector obtained above and

$$[ \begin{matrix}g x \\ g y \\ g z\end{matrix} ]$$

to form an acceleration vector

$${V}_{i} = [ \begin{matrix}V x i \\ V y i \\ V z i\end{matrix} ]$$

(i=1 . . . k, k+1, where, k is an integer not less than 3).

Use

$$[ \begin{matrix}V x i \\ V y i \\ V z i\end{matrix} ]$$

to calculate the included angle ΔVᵢ(ΔVᵢ=Vᵢ₊₁−Vᵢ) in the acceleration directions and obtain the estimated direction change of acceleration.

The disclosure also provides a system that realizes indirect measurement of gravity.

A computer is needed to solve the equations above.

The disclosure is based on the fact that constant change in the relationship between the gravitational force generated by celestial bodies, the gravitational force generated by the Earth, and other inertial forces, will result in minuscule changes in the direction of gravity. The direction of force is the direction of acceleration, and the magnitude of acceleration is proportional to the magnitude of force. Therefore, the measured acceleration is equivalent to the measured force. Furthermore, the change at each position with time is different. By regularly monitoring the direction change of gravitational acceleration of the position, the gravity can be deduced. During the implementation, the direction change of gravity can be ascertained using an inclinometer.

The disclosure offers easy usability and considerable applicability, thus solving the problems of low practicability and difficulty of use present in other technologies. Moreover, it improves the user experience, promising great commercial viability in the market.

### DETAILED DESCRIPTION

Here below provide scenarios to explain the way of implementing the technical solution in this disclosure.

The Earth's gravity is the resultant force of gravitational force and inertial force. The disclosure is based on the fact that constant change in the relationship between the gravitational force generated by celestial bodies, the gravitational force generated by the Earth, and other inertial forces, will result in minuscule changes in the direction of gravity. The direction of the force is the direction of acceleration, and the magnitude of the acceleration is proportional to the magnitude of force. Therefore, the measured acceleration is equivalent to the measured force. Furthermore, the change at each position with time is different. By regularly monitoring the direction change of gravitational acceleration of the position, the gravity can be deduced. The direction change of gravity can be ascertained using an inclinometer.

Supposing that at a certain position on the Earth, its coordinates in the geocentric geo-fixed coordinate system are

$$[ \begin{matrix}x \\ y \\ z\end{matrix} ] ,$$

at any time the gravitational acceleration it receives is generated by the vector synthesis of the following forces: the gravitational force generated by the Earth, the Moon, the Sun and other celestial bodies, the centrifugal force generated by the Earth's rotation, the centrifugal force in the Earth-Moon system, the centrifugal force in the Sun-Earth system, and the gravitational force of other objects (such as nearby heavy objects) that cannot be ignored. These forces are divided into two types, with one type remaining unchanged in a short term, and the other type changing continuously.

The first type of force remains unchanged in a short term, including the gravitational force generated by the Earth and the centrifugal force generated by the Earth's rotation. Generally speaking, the gravitational force of nearby heavy objects will not change greatly in a short term.

The second type of force changes continuously, including the gravitational force generated by the Moon, the Sun and other celestial bodies, the centrifugal force in the Earth-Moon system, and the centrifugal force in the Sun-Earth system.

Though the second type of force changes with time, its operation law has long been known to people. Yet, to accurately calculate its magnitude and direction, knowledge of the exact time is required.

Theoretically, the direction and magnitude of gravity can be accurately calculated only when the time and position are accurately known. However, the gravitational force generated by the Earth cannot be directly calculated by a formula of gravitational forces, because the Earth is an uneven object with complicated internal structure which has a great influence on the gravitational force of the Earth. However, it is feasible to deduce the gravity by changing its direction. This method is immune to horizontal disturbances and can reduce or eliminate most errors caused by gravity anomaly and other factors.

According to the current knowledge, there are many celestial bodies around the Earth. However, due to their different masses and distances from the Earth, they have different influences on gravity. The greatest influence is brought the Moon, followed by the Sun, and then the Venus, the Mars, the Jupiter, the Mercury, and finally the Saturn. Since the current instruments cannot assess the influence of the Venus and other celestial bodies on the Earth's gravitational force, they are not considered here. However, when the instruments' precision is improved, they will surely be considered to achieve higher precision results.

Through calculation, the following results are obtained:

Every one second, the influence of the Moon on the gravity direction of ground objects changes in the order of 10⁻⁶ arcseconds. If the change is to be accurately extracted, the precision of the inclinometer needs to be at least 10⁻¹⁰ arcseconds.

Every 1 minute, the influence of the Moon on the gravity direction of ground objects changes in the order of 10⁻⁵ arcseconds. If the change is to be accurately extracted, the precision of the inclinometer needs to be at least 10⁻⁷ arcseconds.

Every 10 minutes, the influence of the Moon on the gravity direction of ground objects changes in the order of 10⁻⁴ arcseconds. If the change is to be accurately extracted, the precision of the inclinometer needs to be at least 10⁻⁵ arcseconds.

Every 60 minutes, the influence of the Moon on the gravity direction of ground objects changes in the order of 10⁻³ arcseconds. If the change is to be accurately extracted, the precision of the inclinometer needs to be at least 10⁻⁴ arcseconds.

The Sun's influence on direction change of gravity is about ⅓ of that of the Moon. The Sun-Earth and Earth-Moon systems are considered non-inertial systems. The influence of other celestial bodies is smaller. An inclinometer with much higher precision is needed to extract the influence of the Venus, the Mars, the Jupiter, the Mercury, and the Saturn.

The existing technology is able to accurately calculate the trajectories of these celestial bodies, and the only requirement is the accurate time. The precision clock technology is also very advanced. For example, the precision of a cesium clock can easily reach the level of 10⁻¹⁴/5-day, which ensures that the error in one year does not exceed 100 ps. The precision of inclination observation can reach 10⁻⁵ arcseconds. Accurate positioning can also be achieved by means of GNSS. Based on the above equipment, the conditions for calculating gravity according to the direction change of gravitational forces have been met. Obviously, the higher the precision of the inclinometer, the shorter the observation interval, the shorter the calculation period, and the higher the precision of the results. According to the current technology, the improvement of the precision of an inclinometer is much easier than that of a gravimeter, and the cost is much lower. For example, a capacitive inclinometer only needs a plate area of about 100 mm², a pendulum length of 50 mm, and a spacing of 0.25 mm. Its size is like a thermos cup, and it can reach a precision of 10⁻⁵ arcseconds. The precision of an optical inclinometer is also at a similar level. But previously there was no need for inclinometers with higher precision. In specific implementation, the technical scheme of the disclosure can be realized by using a customized inclinometer. Therefore, it can be predicted that the positioning method described in the disclosure may further improve the precision of inclinometers.

The measurement method proposed in the disclosure is as follows:

1) Suppose that the acceleration generated by the Earth's gravitational force is a three-dimensional vector

$$[ \begin{matrix}g x \\ g y \\ g z\end{matrix} ] .$$

In a short time, the direction and magnitude of the Earth's gravitational force have very slight change, therefore it can be deemed as unchanged. Observe the angle of the inclinometer at four or more times t₁, t₂, t₃, t₄ at a certain time interval θ₁, θ₂, θ₃, θ₄ . . . ; and then compare two adjacent observed values to obtain three or more observed value differences Δθ₁, Δθ₂, Δθ₃, where Δθ₁=θ₂−θ₁, Δθ₂=θ₃−θ₂, and Δθ₃=θ₄−θ₃, . . .

2) Use

$$[ \begin{matrix}x \\ y \\ z\end{matrix} ] ,$$

time and position of celestial bodies to accurately calculate the three-dimensional vector

$$[ \begin{matrix}A x i \\ A y i \\ A z i\end{matrix} ]$$

(i=1 . . . k, k+1, where k is an integer not less than 3) of each acceleration other than the above-mentioned acceleration generated by the Earth's gravitational force at each time. Make a vector synthesis with the acceleration generated by the Earth's gravitational force at these times to obtain the gravitational acceleration vector

$${V}_{i} = [ \begin{matrix}V x i \\ V y i \\ V z i\end{matrix} ] ,$$

(i=1 . . . k, k+1, where k is an integer not less than 3). Calculate the included angle of two adjacent gravitational accelerations, that is, more than three calculated direction differences can be obtained ΔV₁, ΔV₂, ΔV₃. . .
ΔV₁=V₂−V₁,
ΔV₂=V₃−V₂,
ΔV₃=V₄−V₃,
. . .

3) Suppose that

$$[ \begin{matrix}g x \\ g y \\ g z\end{matrix} ]$$

is the accurate acceleration at the position of the inclinometer, then Δθ₁, Δθ₂, Δθ₃ . . . should be equal to ΔV₁, ΔV₂, ΔV₃ . . . But in fact,

$$[ \begin{matrix}g x \\ g y \\ g z\end{matrix} ]$$

is an unknown number to be solved. Because ΔV₁, ΔV₂, ΔV₃ . . . is a function of

$$[ \begin{matrix}g x \\ g y \\ g z\end{matrix} ]$$

and time, the above formula for calculating the angle difference can be expressed as follows:

$$\{ \begin{matrix}Δ {V}_{1} = f ( gx , gy , gz , {t}_{1} , {t}_{2} ) \\ Δ {V}_{2} = f ( gx , gy , gz , {t}_{2} , {t}_{3} ) \\ Δ {V}_{3} = f ( gx , gy , gz , {t}_{3} , {t}_{4} ) \\ … …\end{matrix}$$

Where, t₁, t₂, t₃, t₄ . . . are all known accurate observed values, ΔV₁, ΔV, ΔV₃ . . . are known observed value Δθ₁, Δθ₂, Δθ₃ . . . , and f() is a function of direction change with respect to

$$[ \begin{matrix}g x \\ g y \\ g z\end{matrix} ] .$$

Therefore, the above formula becomes an equation system with three unknowns, three or more equations, and most likely a unique solution. The equations are nonlinear and can be solved by Taylor expansion and iteration. After getting the acceleration

$$[ \begin{matrix}g x \\ g y \\ g z\end{matrix} ] ,$$

make vector synthesis with the acceleration generated by other forces, that is, the gravitational acceleration at that point.

To shorten the convergence time and improve the success rate of positioning,

$$[ \begin{matrix}x \\ y \\ z\end{matrix} ]$$

is used to calculate the acceleration generated by the Earth's gravitational force as an initial solution.

To achieve a more accurate solution, the number of observations can be increased to obtain an overdetermined equation system, and then the least square method can be used to solve them.

Even if the self-position is unknown, it is feasible to perform 7 or more observations to obtain over 6 equations, and take the self-position as an unknown number. But this undoubtedly increases the observation time and the calculation load.

The calculation methods mentioned above are well-proven; therefore, the specific process will not be described again.

For the purpose of reference, an example explaining details of how to implement indirect measurement of gravity is provided here below:

To simplify the description, this example only considers the gravitational forces generated by the Moon and the Sun, and the current accurate position is supposed as already known. If other factors are to be considered, it is only necessary to add corresponding conditions by imitating this example. If the current position cannot be obtained, it is necessary to repeat steps 2, 3, and 4 for at least 7 times (i.e., observe the data for more than 7 times), and simultaneously solve a total of 6 unknowns of its self-position and current gravity vector.

1. Equipment required: a high precision clock (generally an atomic clock), computing equipment (computer or other equipment with processor and memory), a precision inclinometer, a positioning device (e.g. a GNSS receiver or a geomagnetic field positioning device);

2. Obtain the current time (Month, Day, Year, Hour, Minute and Second) from the high precision clock, and calculate the positions of the Moon, the Sun and other celestial bodies according to the current time. Since the final position on the Earth is to be calculated, the geocentric geo-fixed coordinate system is generally used. This calculation method is already widely known; therefore, more details will not be described herein;

3. Measure the current gravity direction (inclination angle of the inclinometer);

4. Wait for a period of time;

5. Get the current position

$$[ \begin{matrix}x \\ y \\ z\end{matrix} ]$$

from the positioning device;

6. Repeat steps 2, 3 and 4 for at least 4 times to obtain at least 4 groups of data:

Observation time: t₁, t₂, t₃, t₄ . . .

Lunar coordinates:

$$[ \begin{matrix}{X}_{m 1} \\ {Y}_{m 1} \\ {Z}_{m 1}\end{matrix} ] , [ \begin{matrix}{X}_{m 2} \\ {Y}_{m 2} \\ {Z}_{m 2}\end{matrix} ] , [ \begin{matrix}{X}_{m 3} \\ {Y}_{m 3} \\ {Z}_{m 3}\end{matrix} ] , [ \begin{matrix}{X}_{m 4} \\ {Y}_{m 4} \\ {Z}_{m 4}\end{matrix} ] …$$

Solar coordinates:

$$[ \begin{matrix}{X}_{s 1} \\ {Y}_{s 1} \\ {Z}_{s 1}\end{matrix} ] , [ \begin{matrix}{X}_{s 2} \\ {Y}_{s 2} \\ {Z}_{s 2}\end{matrix} ] , [ \begin{matrix}{X}_{s 3} \\ {Y}_{s 3} \\ {Z}_{s 3}\end{matrix} ] , [ \begin{matrix}{X}_{s 4} \\ {Y}_{s 4} \\ {Z}_{s 4}\end{matrix} ] …$$

Inclination angle: θ₁, θ₂, θ₃, θ₄ . . .

Current position

$$[ \begin{matrix}x \\ y \\ z\end{matrix} ]$$

(if there is a GNSS receiver or other positioning device, the position can be observed);

7. Due to navigation, shaking and other processes, the angle observed by the inclinometer cannot be guaranteed to be the absolute inclination angle, it is necessary to calculate the change of inclination angle Δθᵢ=θᵢ₊₁−θᵢ, (i=1 . . . k, where k is an integer not less than 3) to obtain at least 3 inclination angle changes Δθ₁, Δθ₂, Δθ₃ . . . , from θ₁, θ₂, θ₃, θ₄ . . . ;

8. With

$$[ \begin{matrix}x \\ y \\ z\end{matrix} ] ,$$

observation time tᵢ, lunar coordinates

$$[ \begin{matrix}{X}_{m i} \\ {Y}_{m i} \\ {Z}_{m i}\end{matrix} ]$$

and solar coordinates

$$[ \begin{matrix}{X}_{s i} \\ {Y}_{s i} \\ {Z}_{s i}\end{matrix} ] ,$$

(i=1 . . . k, where k is an integer not less than 3), at each observation time we can obtain the magnitude Ae and direction Ve of the Earth's gravitational force, the magnitude Am and direction Vm of the Moon's gravitational force, the magnitude As and direction Vs of the Sun's gravitational force, as well as the magnitude and direction of centrifugal forces in the Earth's rotation, the Earth-Moon system, and the Sun-Earth system. From these, the magnitude and direction of resultant force can be further calculated, which should be consistent with the observed value;

9. Use

$$[ \begin{matrix}x \\ y \\ z\end{matrix} ]$$

to obtain the approximate value of acceleration vector

$$[ \begin{matrix}g {x}_{0} \\ g {y}_{0} \\ g {z}_{0}\end{matrix} ]$$

generated by the Earth's gravitational force at the current position, which is treated as an initial solution;

10. Suppose that the acceleration vector generated by the Earth's gravitational force is

$$[ \begin{matrix}g x \\ g y \\ g z\end{matrix} ] .$$

Use the initial solution

$$[ \begin{matrix}g {x}_{0} \\ g {y}_{0} \\ g {z}_{0}\end{matrix} ]$$

and the coordinates of celestial bodies (lunar coordinates and solar coordinates) obtained in step 6 to calculate the magnitude and direction of gravitational forces (also the acceleration) at four or more times, and respectively calculate the difference (i.e., the estimated direction change of gravitational acceleration). Then use the observed direction change of gravitational acceleration obtained in step 7 to iterate until the error converges to be less than the error limit, thereby obtaining

$$[ \begin{matrix}g x \\ g y \\ g z\end{matrix} ]$$

and gravitational acceleration at current position. The specific implementation process is as follows:

Calculate the acceleration vector

$$[ \begin{matrix}C x \\ C y \\ C z\end{matrix} ]$$

generated by the Earth's rotation according to its self-position and the Earth's rotation speed;

Calculate the acceleration aₑₘ and its direction vₛₑ in the Earth-Moon system according to the time, lunar mass, lunar coordinates, gravitational constant, geocentric coordinates and its self-position;

Calculate the acceleration aₛₑ and its direction vₛₑ in the Sun-Earth system according to the time, solar mass, solar coordinates, gravitational constant, geocentric coordinates and its self-position;

Compare the three acceleration vectors obtained in the above three steps a, b and c with

$$[ \begin{matrix}g x \\ g y \\ g z\end{matrix} ]$$

for vector synthesis to obtain the acceleration vectors at four or more times

$${V}_{i} = [ \begin{matrix}V x i \\ V y i \\ V z i\end{matrix} ]$$

(i=1 . . . k, k+1, where k is an integer not less than 3);

Use

$$[ \begin{matrix}V x i \\ V y i \\ V z i\end{matrix} ]$$

to calculate the angle of acceleration direction ΔVᵢ, (ΔVᵢ=Vᵢ₊₁−Vᵢ, i=1 . . . k, where k is an integer not less than 3), that is, the estimated direction change of acceleration:
ΔV₁=V₂−V₁,
ΔV₂=V₃−V₂,
ΔV₃=V₄−V₃ . . .

Steps b and c are used to calculate the function of time (independent variable), and step d are used to calculate the function of

$$[ \begin{matrix}g x \\ g y \\ g z\end{matrix} ]$$

and time (independent variables)

$$( [ \begin{matrix}g x \\ g y \\ g z\end{matrix} ]$$

is unknown, and time is known). The result of step e is based on steps b, c and d, so ΔVᵢ is the function of

$$[ \begin{matrix}g x \\ g y \\ g z\end{matrix} ] .$$

The equations are as follows:

$$\{ \begin{matrix}\begin{matrix}Δ {V}_{1} = f ( gx , gy , gz , {t}_{1} , {t}_{2} ) \\ Δ {V}_{2} = f ( gx , gy , gz , {t}_{2} , {t}_{3} ) \\ Δ {V}_{3} = f ( gx , gy , gz , {t}_{3} , {t}_{4} )\end{matrix} \\ … …\end{matrix} \qquad ( 1 )$$

ƒ( ) is the difference of direction with respect to

$$[ \begin{matrix}g x \\ g y \\ g z\end{matrix} ] .$$

Residual ωi=ΔVᵢ−Δθᵢ(i=1 . . . k, where k is an integer not less than 3). Only when

$$[ \begin{matrix}g x \\ g y \\ g z\end{matrix} ]$$

is the exact value of the Earth's gravitational force at the point of observation, the residuals are 0, and Δθi is a known observed value. Thus f( ) is also a function of residual ωi with respect to

$$[ \begin{matrix}g x \\ g y \\ g z\end{matrix} ] .$$

At

$$[ \begin{matrix}g {x}_{0} \\ g {y}_{0} \\ g {z}_{0}\end{matrix} ] ,$$

linearize Equation (1) with Taylor unfolding, resulting in:

$$Gv \cdot Δ [ \begin{matrix}g {x}_{0} \\ g {y}_{0} \\ g {z}_{0}\end{matrix} ] = Δ ( Δ V ) \qquad ( 2 )$$

Where Gv is the Jacobian matrix corresponding to f(),

$$Δ [ \begin{matrix}g {x}_{0} \\ g {y}_{0} \\ g {z}_{0}\end{matrix} ]$$

is the difference between current and previous solutions (taking the result of the first iteration as the initial solution), Δ(ΔV) is the difference in acceleration directions between current and previous solutions (taking the result of the first iteration as the initial solution). Import ωi into Equation (2) to obtain

$$Δ [ \begin{matrix}g {x}_{0} \\ g {y}_{0} \\ g {z}_{0}\end{matrix} ] .$$

The current solution is

$$[ \begin{matrix}g {x}_{n} \\ g {y}_{n} \\ g {z}_{n}\end{matrix} ] = [ \begin{matrix}g {x}_{0} \\ g {y}_{0} \\ g {z}_{0}\end{matrix} ] + Δ [ \begin{matrix}g {x}_{0} \\ g {y}_{0} \\ g {z}_{0}\end{matrix} ] ,$$

which updates the solution of the Earth's gravitational force. Compared with

$$[ \begin{matrix}g {x}_{0} \\ g {y}_{0} \\ g {z}_{0}\end{matrix} ] , [ \begin{matrix}g {x}_{n} \\ g {y}_{n} \\ g {z}_{n}\end{matrix} ]$$

is closer to the Earth's actual gravitational force at the observation point. Iterate like this until

$$Δ [ \begin{matrix}g {x}_{0} \\ g {y}_{0} \\ g {z}_{0}\end{matrix} ]$$

is less than the predetermined limit, the solution thus obtained is taken as the final solution, and the measurement is completed.

Usually, k is greater than 3; therefore, we can obtain an overdetermined equation system which improves the reliability of the result. Then, with

$$[ \begin{matrix}g {x}_{0} \\ g {y}_{0} \\ g {z}_{0}\end{matrix} ]$$

as an initial solution, least squares are used to calculate the acceleration vector

$$[ \begin{matrix}g x \\ g y \\ g z\end{matrix} ]$$

generated by the Earth's gravitational force at the current position, which is then synthesized with the acceleration generated by other forces in steps a, b, c, thereby obtaining the gravitational acceleration at the current position.

All mass objects situated on the Earth are affected by gravity, so the range of application is rather extensive. To illustrate, utilizing gravity to measure the weight of items in supermarkets. The gravity which will be talked about herein is related to high-precision gravity measurement in national economy, military affairs, science, etc. The purpose of gravity measurement is to study the Earth's gravity field. Analyzing the gravity field is helpful for people to understand the terrain of the Earth, the distribution of materials in the Earth and its internal structure. Therefore, gravity research is mainly useful for the following purposes:

### (1) Space Exploration

When propelling a space probe from the Earth, the gravity of the probe is of utmost importance. The propeller's capability limitation restricts the mass range of the probe. In addition, other celestial bodies like the Moon possess a gravity field similar to the Earth's. Therefore, the study of gravity field provides a crucial premise and basis for space exploration.

### (2) Military

Since all objects with mass are affected by gravity, missiles are no exception. Nevertheless, the size of the Earth's gravity field on the Earth's surface changes, the influence of gravity must be taken into account in how to accurately hit the target. In addition, the launching and precise tracking of military satellites require an understanding of gravity field. Consequently, the importance of gravity in military affairs is obvious.

### (3) Science

In scientific research, gravity is the only means, besides seismology, with which to understand the Earth's interior, thus having vital significance in refining the Earth model and studying the physics of the Earth's deep interior. Moreover, it has yielded many research results of practical significance in regards to detection and prediction of natural disasters, including earthquakes and volcanoes. In addition, all observational instruments, be they ground-based or in space-borne, will be affected by gravity, so the gravity influence of observational results needs to be considered.

### (4) National Economy

Coupled with geology, geomagnetism and geochemistry, gravity measurement can detect the distribution of materials on the Earth's surface, serving as an efficient tool for resource exploration and contributing to economic growth.

In brief, gravity has various applications. The current Earth model is capable of accurately calculating the changes of gravity tide. In addition, humans are increasingly able to accurately determine the Earth's structure, density and other parameters, thus driving the research of gravity towards higher precision (micro gamma or above).

In practice, the method outlined in the disclosure can be implemented by those with expertise in the field of computer science, employing suitable software technologies. Moreover, the systems and devices which incorporate the implementation, such as computer storage media with appropriate computer program, and the computers on which the program is executed—are within the scope of protection set forth by this disclosure.

In certain scenarios, a gravitational force positioning system may be provided, comprising a processor and memory, with the memory being used to store program instructions, and the processor being used to call the stored instructions in the memory to execute the gravitational force positioning method as described above.

In certain scenarios, a gravitational force positioning system may be provided, comprising a readable storage medium storing a computer program. Upon execution of said computer program, a gravitational force positioning method as described above is realized.

In certain scenarios, a plurality of inclinometers can be used to eliminate some errors and obtain more accurate and reliable results.

The specific scenarios described herein are merely illustrative of the principles of the disclosure. Those skilled in the art to which the disclosure pertains may make modifications or supplements to the described scenarios or adopt similar methods to replace them, but they should not deviate from the principles of the disclosure or exceed the scope defined in the appended claims.

What is claimed is:

1. A method for indirectly measuring gravity, with instruments used comprising a precision inclinometer, a precision clock, a computer, and a positioning device;
the method comprising:
storing astronomical ephemeris in the computer;
obtaining current time from the precision clock;
obtaining position from the positioning device;
calculating a celestial body's current position based on the astronomical ephemeris, current time and its position;
measuring a direction of gravity θ₁, θ₂, . . . , θₖ₊₁ with the precision inclinometer at time t₁, t₂, . . . , tₖ₊₁; obtaining a direction change of gravitational acceleration: Δθᵢ =θᵢ₊₁−θᵢ where i=1 . . . k; calculating acceleration vectors V₁, V₂, . . . , Vₖ₊₁ generated by resultant gravitational forces of related celestial bodies at time t₁, t₂, . . . , tₖ₊₁ according to their coordinates
$$[ \begin{matrix}x \\ y \\ z\end{matrix} ]$$
and positions;
calculating the direction change of acceleration: ΔVᵢ=Vᵢ₊₁−Vᵢ, wherein i=1 . . . k, where k is an integer not less than 3;
assuming an acceleration caused by the Earth's gravitational force as a three-dimensional vector
$$[ \begin{matrix}g x \\ g y \\ g z\end{matrix} ] ;$$
building an equation system for calculating the direction change of gravitational acceleration as follows,
$$\{ \begin{matrix}\begin{matrix}Δ {V}_{1} = f ( gx , gy , gz , {t}_{1} , {t}_{2} ) \\ Δ {V}_{2} = f ( gx , gy , gz , {t}_{2} , {t}_{3} ) \\ Δ {V}_{3} = f ( gx , gy , gz , {t}_{3} , {t}_{4} )\end{matrix} \\ … …\end{matrix}$$
where f( ) is a function of direction change with respect to
$$[ \begin{matrix}g x \\ g y \\ g z\end{matrix} ] ;$$
deducing a gravity measurement at the position to be measured as follows: using its coordinates
$$[ \begin{matrix}x \\ y \\ z\end{matrix} ]$$
to calculate approximate value
$$[ \begin{matrix}g {x}_{0} \\ g {y}_{0} \\ g {z}_{0}\end{matrix} ]$$
of an acceleration vector generated by the Earth at the current position; taking the approximate value as an initial solution to calculate an estimated direction change of gravitational acceleration; utilizing observed direction change of gravitational acceleration and relevant equation system to iterate until an error converges to be less than an error limit, thereby getting a result of gravity measurement.

2. The method of claim 1, wherein monitoring the direction change of gravitational acceleration is achieved by an inclinometer.

3. The method of claim 1, wherein the current time is obtained from an atomic clock.

4. The method of claim 1, wherein if a positioning device is not available, 6 unknown variables comprising 3 dimension positions and 3 axis gravity vectors are solved by collecting data from at least seven observations.

5. The method of claim 1, wherein the celestial body comprises the Sun, the Moon and other near earth celestial bodies.

6. The method of claim 5, wherein the direction change of gravitational acceleration is estimated as follows:
calculating an acceleration vector
$$[ \begin{matrix}C x \\ C y \\ C z\end{matrix} ]$$
generated by the Earth's rotation according to its position and Earth's rotation speed;
calculating an acceleration aₑₘ and its direction vₑₘ in the Earth-Moon system based on the time, lunar mass, lunar coordinates, gravitational constant, geocentric coordinates, and its self-position;
calculating an acceleration aₛₑ and its direction vₛₑ in the Sun-Earth system according to the time, solar mass, solar coordinates, gravitational constant, geocentric coordinates, and its self-position;
making a vector synthesis with the above acceleration vector and
$$[ \begin{matrix}g x \\ g y \\ g z\end{matrix} ]$$
to form an acceleration vector
$${V}_{i} = [ \begin{matrix}V x i \\ V y i \\ V z i\end{matrix} ] ,$$
wherein i=1 . . . k, k+1, and k is an integer not less than 3; and
using
$$[ \begin{matrix}V x i \\ V y i \\ V z i\end{matrix} ]$$
to calculate an included angle ΔVᵢ=Vᵢ₊₁−Vᵢ in an acceleration direction and obtain the estimated direction change of acceleration.

7. A system comprising a processor and a memory for indirectly measuring gravity according to the method of claim 1.
